(19) United States
(12) Patent Application Publication
(10) Pub. No.: US 2018/0129913 A1
(43) Pub. Date: May 10, 2018

(54) DRONE COMPRISING A DEVICE FOR DETERMINING A REPRESENTATION OF A TARGET VIA A NEURAL NETWORK, RELATED DETERMINATION METHOD AND COMPUTER

(71) Applicant: PARROT DRONES, Paris (FR)

(72) Inventors: Lea VAUCHIER, PARIS (FR); Alexandre BRIOT, PARIS (FR)

(21) Appl. No.: 15/804,239

(22) Filed: Nov. 6, 2017

(30) Foreign Application Priority Data
Nov. 9, 2016 (FR) 16 60845

(51) Int. Cl. G06K 9/62; G06K 9/00; G05D 1/00; B64C 39/02

(52) U.S. Cl. CPC G06K 9/6267; G06K 9/0063; B64C 2201/146; B64C 39/024; B64C 2201/127; G05D 1/0094

(57) ABSTRACT

This drone includes an image sensor configured to take an image of a scene including a plurality of objects, and an electronic determination device including an electronic detection module configured to detect, via a neural network, in the image taken by the image sensor, a representation of a potential target from among the plurality of objects represented, an input variable of the neural network being an image depending on the image taken, at least one output variable of the neural network being an indication relative to the representation of the potential target. A first output variable of the neural network is a set of coordinates defining a contour of a zone surrounding the representation of the potential target.

### FIELD OF THE INVENTION

The present invention relates to a drone. The drone comprises an image sensor configured to take an image of a scene including a plurality of objects, and an electronic determination device including an electronic detection module configured to detect, in the image taken by the image sensor, a depiction of a potential target from among the plurality of objects shown.

The invention also relates to a method for determining a representation of a potential target from among a plurality of objects represented in an image, the image coming from an image sensor on board a drone.

The invention also relates to a non-transitory computer-readable medium comprising a computer program including software instructions which, when executed by a computer, implement such a determination method.

The invention in particular relates to the field of drones, i.e., remotely-piloted flying motorized apparatuses. The invention in particular applies to rotary-wing drones, such as quadricopters, while also being applicable to other types of drones, for example fixed-wing drones.

The invention is particularly useful when the drone is in a tracking mode in order to track a given target, such as the pilot of the drone engaging in an athletic activity.

The invention offers many applications, in particular for initializing tracking of moving targets or for slaving, or recalibration, of such tracking of moving targets.

### BACKGROUND OF THE INVENTION

A drone of the aforementioned type is known from the publication “Moving Vehicle Detection with Convolutional Networks in UAV Videos” by Qu et al. The drone comprises an image sensor able to take an image of a scene including a plurality of objects, and an electronic device for determining a representation of a potential target from among the plurality of objects shown.

The determination device first detects zones surrounding candidate representations of the target and calculates contours of the zones, each contour being in the form of a window, generally rectangular, this detection being done using a traditional frame difference method or background modeling. The determination device secondly classifies the candidate representations of the target using a neural network with, as input variables, the contours of zones previously detected and, as output variables, a type associated with each candidate representation, the type being chosen from among a vehicle and a background. The neural network then makes it possible to classify the candidate representations of the target between a first group of candidate representations each capable of corresponding to a vehicle and a second group of candidate representations each capable of corresponding to a background.

However, the determination of the representation of the target with such a drone is relatively complex.

### SUMMARY OF THE INVENTION

The aim of the invention is then to propose a drone that is more effective for the determination of the representation of the target, in particular not necessarily requiring knowing the position of the target to be able to detect a representation thereof in the image.

To that end, the invention relates to a drone, comprising:
an image sensor configured to take an image of a scene including a plurality of objects,
an electronic determination device including an electronic detection module configured to detect, via a neural network, in the image taken by the image sensor, a representation of a potential target from among the plurality of objects represented, an input variable of the neural network being an image depending on the image taken, at least one output variable of the neural network being an indication relative to the representation of the potential target, a first output variable of the neural network being a set of coordinates defining a contour of a zone surrounding the representation of the potential target.

With the drone according to the invention, the neural network, implemented by the electronic detection network, makes it possible to obtain, as output, a set of coordinates defining a contour of a zone surrounding the representation of the potential target, directly from an image provided as input of said neural network.

Unlike the drone of the state of the art, it is then not necessary to obtain, before implementing the neural network, a frame difference or a background modeling to estimate said zone surrounding a representation of the target.

According to other advantageous aspects of the invention, the drone comprises one or more of the following features, considered alone or according to all technically possible combinations:
a second output variable of the neural network is a category associated with the representation of the target,
   the category preferably being chosen from among the group consisting of: a person, an animal, a vehicle, a furniture element contained in a residence;
a third output variable of the neural network is a confidence index by category associated with each representation of a potential target;
the electronic detection module is further configured to ignore a representation having a confidence index below a predefined threshold;
the electronic determination device further includes an electronic tracking module configured to track, in different images taken successively by the image sensor, a representation of the target;
the electronic determination device further includes an electronic comparison module configured to compare a first representation of the potential target obtained from the electronic detection module with a second representation of the target obtained from the electronic tracking module; and
the neural network is a convolutional neural network.

The invention also relates to a method for determining a representation of a potential target from among a plurality of objects represented in an image, the image being taken from an image sensor on board a drone,

the method being implemented by an electronic determination device on board the drone, and comprising:
acquiring at least one image of a scene including a plurality of objects,
detecting, via a neural network, in the acquired image, a representation of the potential target from among the plurality of objects represented, an input variable of the neural network being an image depending on the acquired image, at least one output variable of the neural network being an indication relative to the representation of the potential target,

a first output variable of the neural network being a set of coordinates defining a contour of a zone surrounding the representation of the potential target.

According to other advantageous aspects of the invention, the determination method comprises one or more of the following features, considered alone or according to all technically possible combinations:
the method further comprises tracking, in different images acquired successively, a representation of the target; and
the method further comprises comparing first and second representations of the target, the first representation of the potential target being obtained via the detection with the neural network, and the second representation of the target being obtained via the tracking of the representation of the target in different images acquired successively.

The invention also relates to a non-transitory computer-readable medium comprising a computer program including software instructions which, when executed by a computer, implement a method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of a drone comprising at least one image sensor and an electronic device for determining representation(s) of one or several potential targets from among the plurality of objects represented in one or several images taken by the image sensor;

FIG. 2 is an illustration of an artificial neural network implemented by a detection module included in the determination device of FIG. 1;

FIG. 3 is an illustration of the neural network in the form of successive processing layers; and

FIG. 4 is a flowchart of a method for determining representation(s) of one or several potential targets according to the invention.

### DETAILED DESCRIPTION OF PREFERRED EMBODIMENTS

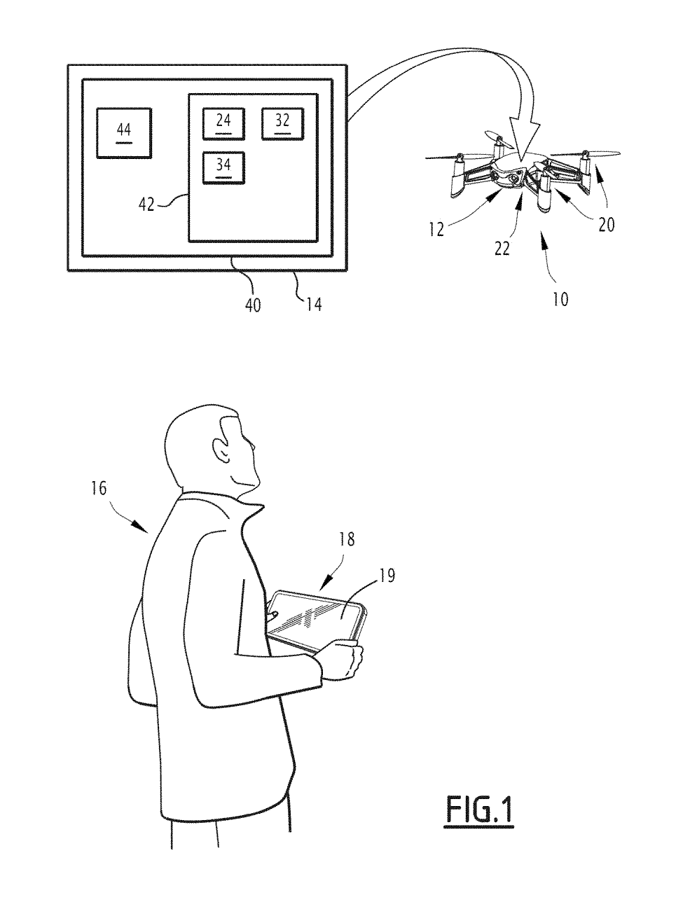

In FIG. 1, a drone 10, i.e., an aircraft with no pilot on board, comprises an image sensor 12 configured to take an image of a scene including a plurality of objects, and an electronic determination device 14 configured to determine one or several representations of one or several potential targets 16 from among the plurality of objects represented in the image taken by the sensor 12.

The drone 10 is a motorized flying vehicle able to be piloted remotely, in particular via a joystick 18.

The drone 10 is for example a rotary-wing drone, including at least one rotor 20. In FIG. 1, the drone includes a plurality of rotors 20, and is then called multi-rotor drone. The number of rotors 20 is in particular equal to 4 in this example, and the drone 10 is then a quadrirotor drone. In an alternative that is not shown, the drone 10 is a fixed-wing drone.

The drone 10 includes a transmission module 22 configured to exchange data, preferably by radio waves, with one or several pieces of electronic equipment, in particular with the lever 18, or even with other electronic elements to transmit the image(s) acquired by the image sensor 12.

The image sensor 12 is for example a front-viewing camera making it possible to obtain an image of the scene toward which the drone 10 is oriented. Alternatively or additionally, the image sensor 12 is a vertical-viewing camera, not shown, pointing downward and configured to capture successive images of terrain flown over by the drone 10.

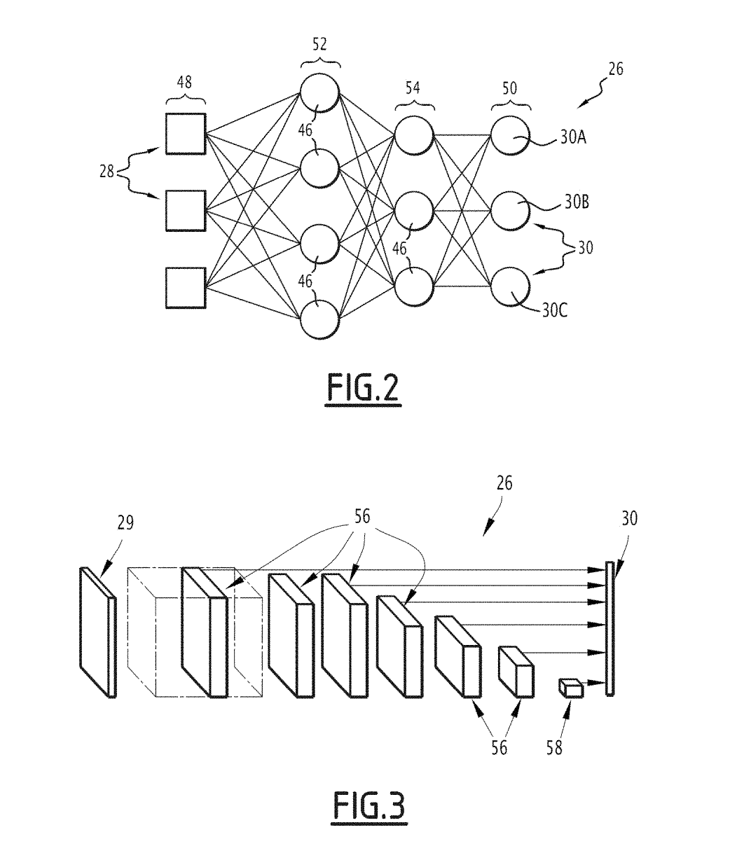

The electronic determination device 14 is on board the drone 10, and includes an electronic detection module 24 configured to detect, in the image taken by the image sensor 12 and via an artificial neural network 26, shown in FIGS. 2 and 3, the representation(s) of one or several potential targets 16 from among the plurality of objects represented in the image. An input variable 28 of the artificial neural network is an image depending on the image taken, and at least one output variable 30 of the artificial neural network is an indication relative to the representation(s) of one or several potential targets 16.

The electronic determination device 14 according to the invention is used for different applications, in particular for the initialization of moving target tracking or for the slaving, or recalibration, of such moving target tracking.

A “potential target”, also called possible target, is a target whose representation will be detected via the electronic determination device 14 as a target potentially to be tracked, but that will not necessarily be a target tracked in fine by the drone 10. Indeed, the target(s) to be tracked by the drone 10, in particular by its image sensor 12, will be the target(s) that have been selected, by the user or by another electronic device in case of automatic selection without intervention by the user, as target(s) to be tracked, in particular from among the potential target(s) determined via the electronic determination device 14.

As an optional addition, the electronic determination device 14 further includes an electronic tracking module 32 configured to track, in different images taken successively by the image sensor 12, a representation of the target 16.

As an optional addition, the electronic determination device 14 further includes an electronic comparison module 34 configured to compare one or several first representations of one or several potential targets 16 from the electronic detection module 24 with a second representation of the target 16 from the electronic tracking module 32.

In the example of FIG. 1, the electronic determination device 14 includes an information processing unit 40, for example made up of a memory 42 and a processor 44 of the GPU (Graphics Processing Unit) or VPU (Vision Processing Unit) type associated with the memory 42.

The target 16 is for example a person, such as the pilot of the drone 10, the electronic determination system 14 being particularly useful when the drone 10 is in a tracking mode to track the target 16, in particular when the pilot of the drone 10 is engaged in an athletic activity. One skilled in the art will of course understand that the invention applies to any type of target 16 having been subject to learning by the neural network 26, the target 16 preferably being a moving target. The learning used by the neural network 26 to learn the target type is for example supervised learning. Learning is said to be supervised when the neural network 26 is forced to converge toward a final state, at the same time that a pattern is presented to it.

The electronic determination device 14 is also useful when the drone 10 is in a mode pointing toward the target, allowing the drone 10 still to aim for the target 16, but without moving alone, allowing the pilot the possibility of changing the relative position of the drone 10, for example by rotating around the target.

The lever 18 is known in itself, and makes it possible to pilot the drone 10. In the example of FIG. 1, the lever 18 is implemented by a smartphone or electronic tablet, including a display screen 19, preferably touch-sensitive. In an alternative that is not shown, the lever 18 comprises two gripping handles, each being intended to be grasped by a respective hand of the pilot, a plurality of control members, including two joysticks, each being arranged near a respective gripping handle and being intended to be actuated by the pilot, preferably by a respective thumb.

The lever 18 comprises a radio antenna and a radio transceiver, not shown, for exchanging data by radio waves with the drone 10, both uplink and downlink.

In the example of FIG. 1, the detection module 24 and, optionally and additionally, the tracking module 32 and the comparison module 34, are each made in the form of software executable by the processor 44. The memory 42 of the information processing unit 40 is then able to store detection software configured to detect, via the artificial neural network 26, in the image taken by the image sensor 12, one or several representation(s) of one or several potential targets 16 from among the plurality of objects represented in the image. As an optional addition, the memory 42 of the information processing unit 40 is also able to store tracking software configured to track a representation of the target 16 in different images taken successively by the image sensor 12, and comparison software configured to compare the first representation(s) of potential targets from the detection software with a second representation of the target from the tracking software. The processor 44 of the information processing unit 40 is then able to execute the detection software as well as, optionally and additionally, the tracking software and the comparison software.

In an alternative that is not shown, the detection module 24 and, optionally and additionally, the tracking module 32 and the comparison module 34, are each made in the form of a programmable logic component, such as an FPGA (Field Programmable Gate Array), or in the form of a dedicated integrated circuit, such as an ASIC (Applications Specific Integrated Circuit).

The electronic detection module 24 is configured to detect, via the artificial neural network 26 and in the image taken by the image sensor 12, the representation(s) of one or several potential targets 16 from among the plurality of represented objects, an input variable 28 of the artificial neural network being an image 29 depending on the image taken by the image sensor 12, and at least one output variable 30 of the neural network being an indication relative to the representation(s) of one or several potential targets 16.

The neural network 26 includes a plurality of artificial neurons 46 organized in successive layers 48, 50, 52, 54, i.e., an input layer 48 corresponding to the input variable(s) 28, an output layer 50 corresponding to the output variable(s) 30, and optional intermediate layers 52, 54, also called hidden layers and arranged between the input layer 48 and the output layer 50. An activation function characterizing each artificial neuron 46 is for example a nonlinear function, for example of the Rectified Linear Unit (ReLU) type. The initial synaptic weight values are for example set randomly or pseudo-randomly.

The artificial neural network 26 is in particular a convolutional neural network, as shown in FIG. 3.

The artificial neural network 26 for example includes artificial neurons 46 arranged in successive processing layers 56, visible in FIG. 3 and configured to successively process the information on a limited portion of the image, called receptive field, on the one hand through a convolution function, and on the other hand through pooling neurons of the outputs. The set of outputs of a processing layer forms an intermediate image, serving as the base for the following layer.

The artificial neural network 26 is preferably configured such that the portions of the image to be processed, i.e., the receptive fields, overlap in order to obtain a better representation of the original image 29, as well as better coherence of the processing over the course of the processing layers 56. The overlapping is defined by a pitch, i.e., an offset between two adjacent receptive fields.

The artificial neural network 26 includes one or several convolution kernels. A convolution kernel analyzes a characteristic of the image to obtain, from the original image 29, a new characteristic of the image in a given layer, this new characteristic of the image also being called channel (also referred to as a feature map). The set of channels forms a convolutional processing layer, in fact corresponding to a volume, often called output volume, and the output volume is comparable to an intermediate image.

The convolution kernels of the neural network 26 preferably have odd sizes, to have spatial information centered on a pixel to be processed. The convolution kernels of the neural network 26 are then 3×3 convolution kernels or 5×5 convolution kernels, preferably 3×3 convolution kernels, for the successive image analyses in order to detect the representations of one or several potential targets. The 3×3 convolution kernels make it possible to occupy a smaller space in the memory 42 and perform the calculations more quickly with a short inference time, compared with the 5×5 convolution kernels. Some convolutions are preferably dilated convolutions, which makes it possible to have a wider receptive field with a limited number of layers, for example fewer than 50 layers, still more preferably fewer than 40 layers. Having a wider receptive field makes it possible to account for a larger visual context when detecting the representation(s) of one or several potential targets 16.

The neural network 26 then includes the channels for each layer 56, a channel being, as previously indicated, a characteristic of the original image 29 at a given layer. In the case of an implementation in a drone whose calculating resources are limited, the number of channels for each layer 56 is preferably small; the maximum number of channels for each layer 56 for example being equal to 1024, also preferably to 512 for the last layer. The minimum number of channels for each layer 56 is for example equal to 1.

According to this addition, the neural network 26 further includes compression kernels 58, such as 1×1 convolution kernels, configured to compress the information, without adding information related to the spatial environment, i.e., without adding information related to the pixels arranged around the pixel(s) considered in the analyzed characteristic, the use of these compression kernels making it possible to eliminate the redundant information. Indeed, an overly high number of channels may cause duplication of the useful information, and the compression then seeks to resolve such a duplication.

As an optional addition, the neural network 26 includes a dictionary of reference boxes, from which the regressions are done that calculate the output boxes. The dictionary of reference boxes makes it possible to account for the fact that taking an aerial view may distort the objects, with recognition of the objects from a particular viewing angle, different from the viewing angle when taken from the ground. The dictionary of reference boxes also makes it possible to account for a size of the objects taken from the sky different from that taken from the ground. The size of the smallest reference boxes is then for example chosen to be smaller than or equal to one tenth of the size of the initial image 29 provided as input variable for the neural network 26.

The learning of the neural network 26 is preferably supervised. It then for example uses a back-propagation algorithm of the error gradient, such as an algorithm based on minimizing an error criterion by using a so-called gradient descent method.

The image 29 provided as input variable for the neural network 26 preferably has dimensions smaller than or equal to 512 pixels×512 pixels.

According to the invention, a first output variable 30A of the neural network 26 is a set of coordinates defining one or several contours of one or several zones surrounding the representations of the potential targets 16.

A second output variable 30B of the neural network 26 is a category associated with the representation of the target, the category preferably being chosen from among the group consisting of: a person, an animal, a vehicle, a piece of furniture contained in a residence, such as a table, a chair, a robot.

As an optional addition, a third output variable 30C—of the neural network 26 is a confidence index by category associated with the representations of potential targets 16. According to this addition, the electronic detection module 24 is then preferably further configured to ignore a representation having a confidence index below a predefined threshold.

The electronic tracking module 32 is configured to track, in different images taken successively by the image sensor 12, a representation of the target 16, and the set of coordinates defining a contour of a zone surrounding the representation of the target 16, coming from the neural network 26 and provided by the detection module 24, then allows initialization of the tracking of one or several targets 16 or slaving, or recalibration, of the tracking of the target(s) 16, preferably moving targets.

The comparison module 34 is configured to compare one or several first representations of one or several potential targets 16 from the detection module 24 with a second representation of the target 16 from the tracking module 32, and the result of the comparison is for example used for the slaving, or recalibration, of the tracking of the target(s) 16.

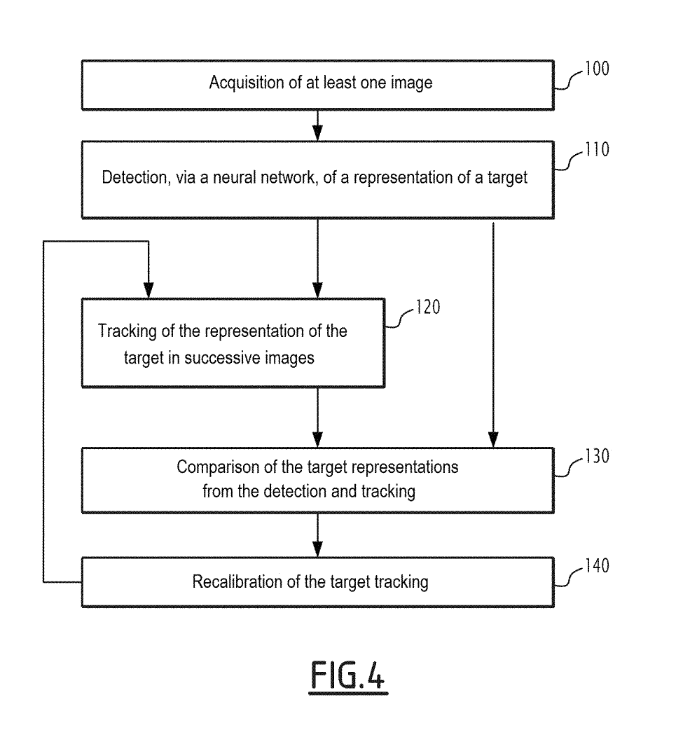

The operation of the drone 10 according to the invention, in particular of its electronic determination module 14, will now be described using FIG. 4, illustrating a flowchart of the determination method according to the invention, implemented by computer.

During an initial step 100, the detection module 24 acquires an image of a scene including a plurality of objects, including one or several targets 16, the image having been taken by the image sensor 12.

The detection module 24 next detects, during step 110, in the acquired image and using its artificial neural network 26, the representations of one or several potential targets 16 from among the plurality of represented objects, an input variable 28 of the neural network 26 being an image 29 depending on the acquired image and the first output variable 30A of the neural network 26 being a set of coordinates defining one or several contours of one or several zones surrounding the representations of one or several potential targets 16. The zone thus detected is preferably a rectangular zone, also called window.

As an optional addition, during step 110, the detection module 24 can also calculate a confidence index by category associated with the representation(s) of one or several potential targets 16, this confidence index being the third output variable 30C of the neural network 26. According to this addition, the detection module 24 is then further able to ignore a representation having a confidence index below a predefined threshold.

As another optional addition, during step 110, the detection module 24 further determines one or several categories associated with the representations of one or several potential targets 16, this category for example being chosen from among a person, an animal, a vehicle, a piece of furniture contained in a residence, such as a table, a chair, a robot. This category is the second output variable 30B of the neural network 26.

The zone(s) surrounding each representation of one or several respective potential targets 16, estimated during step 110 by the detection module 24, are next used, during step 120, to track the target representation(s) 16 in successive images taken by the image sensor 12. The zone(s) surrounding each representation of one or several respective potential targets 16 are for example displayed on the display screen 19 of the lever 18, superimposed on the corresponding images from the image sensor 12, so as to allow the user to initialize the target tracking by choosing the target 16 that the tracking module 32 must track, this choice for example being made by touch-sensitive selection on the screen 19 of the zone corresponding to the target 16 to be tracked.

The zone(s) surrounding each representation of one or several respective potential targets 16, estimated during step 110 by the detection module 24, are additionally used, during step 130, to be compared, by the comparison module 34, to the target representation 16 from the tracking module 32, and the result of the comparison 34 then allows a recalibration, i.e., slaving, of the tracking of targets 16 during step 140.

The electronic determination device 14 then makes it possible to determine one or several representations of potential targets 16 more effectively from among the plurality of objects represented in the image taken by the sensor 12, the neural network 26 implemented by the detection module 24 making it possible to estimate a set of coordinates directly, defining one or several contours of zones surrounding the representations of one or several potential targets 16 for each target 16.

Optionally, the neural network 26 also makes it possible to calculate, at the same time, a confidence index by category associated with the representation of one or several potential targets 16, which makes it possible to ignore a representation having a confidence interval below a predefined threshold.

Also optionally, the neural network 26 also makes it possible to determine one or several categories associated with the representation of one or several potential targets 16, this category for example being chosen from among a person, an animal and a vehicle, such as a car, and this category determination then makes it possible for example to facilitate the initialization of the target tracking, by optionally displaying only the target(s) 16 corresponding to a predefined category from among the aforementioned categories.

One can thus see that the drone 10 according to the invention and the associated determination method are more effective than the drone of the state of the art to determine the representation of the target, by not requiring obtaining, prior to implementing the neural network 26, a frame difference or background modeling to estimate the zones surrounding a representation of the target 16, and by also not requiring knowing the position of the target 16 to be able to detect a representation thereof in the image.

1. A drone, comprising:
an image sensor configured to take an image of a scene including a plurality of objects,
an electronic determination device including an electronic detection module configured to detect, via a neural network, in the image taken by the image sensor, a representation of a potential target from among the plurality of objects represented, an input variable of the neural network being an image depending on the image taken, at least one output variable of the neural network being an indication relative to the representation of the potential target,
wherein a first output variable of the neural network is a set of coordinates defining a contour of a zone surrounding the representation of the potential target.

2. The drone according to claim 1, wherein a second output variable of the neural network is a category associated with the representation of the target.

3. The drone according to claim 2, wherein the category is chosen from among the group consisting of: a person, an animal, a vehicle, a furniture element contained in a residence.

4. The drone according to claim 2, wherein a third output variable of the neural network is a confidence index by category associated with each representation of a potential target.

5. The drone according to claim 4, wherein the electronic detection module is further configured to ignore a representation having a confidence index below a predefined threshold.

6. The drone according to claim 1, wherein the electronic determination device further includes an electronic tracking module configured to track, in different images taken successively by the image sensor, a representation of the target.

7. The drone according to claim 6, wherein the electronic determination device further includes an electronic comparison module configured to compare a first representation of the potential target obtained from the electronic detection module with a second representation of the target obtained from the electronic tracking module.

8. The drone according to claim 1, wherein the neural network is a convolutional neural network.

9. A method for determining a representation of a target from among a plurality of objects represented in an image, the image being taken from an image sensor on board a drone,
the method being implemented by an electronic determination device on board the drone, and comprising:
acquiring at least one image of a scene including a plurality of objects,
detecting, via a neural network, in the acquired image, a representation of the potential target from among the plurality of objects represented, an input variable of the neural network being an image depending on the acquired image, at least one output variable of the neural network being an indication relative to the representation of the potential target,
wherein a first output variable of the neural network is a set of coordinates defining a contour of a zone surrounding the representation of the potential target.

10. The method according to claim 9, wherein the method further comprises tracking, in different images acquired successively, a representation of the target.

11. The method according to claim 10, wherein the method further comprises comparing first and second representations of the target, the first representation of the potential target being obtained via the detection with the neural network, and the second representation of the target being obtained via the tracking of the representation of the target in different images acquired successively.

12. A non-transitory computer-readable medium comprising a computer program including software instructions which, when executed by a computer, implement a method according to claim 9.
